(19) United States
(12) Patent Application Publication
(10) Pub. No.: US 2010/0265570 A1
(43) Pub. Date: Oct. 21, 2010

(54) Tuneable Optical Amplifier or Optical Parametric Oscillator

(76) Inventor: Stuart Murdoch, North Shore City (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/707,401

(22) Filed: Feb. 17, 2010

Related U.S. Application Data
(60) Provisional application No. 61/153,365, filed on Feb. 18, 2009.

(51) Int. Cl. H01S 3/09

(52) U.S. Cl. 359/341.3

(57) ABSTRACT

A parametric process for producing light at a second wavelength and a fourth wavelength including pumping an optical parametric oscillator with input light at a first wavelength of less than one micron, wherein said oscillator consists of an optical fibre having each end closed by a dichroic mirror.

### CROSS-REFERENCE TO RELATED APPLICATIONS

This application claims the benefit of provisional application No. 61/153,365 filed on Feb. 18, 2009 the entire disclosure of which is incorporated herein by reference.

### FIELD OF INVENTION

The invention relates to devices that convert light from one wavelength to another and in particular, but not exclusively, to a photonic crystal fibre based optical parametric oscillator that converts red or infrared light to lower wavelength visible light and to higher wavelength light.

### BACKGROUND

A source of coherent tuneable blue, green, or yellow light, or far infrared light would have a substantial number of potential applications. A means of converting readily available red laser diode radiation into blue, green, or yellow light would also be advantageous. However, there are presently no solid state tuneable lasers operating at these wavelengths. Tuneable optical parametric oscillators operating at very high peak powers are too expensive to use in everyday optical fibre systems.

Previous fibre optic parametric oscillators have used a pump in the anomalous dispersion region close to the zero group velocity dispersion (GVD) of the fibre, where the parametric amplification gain is also called modulation instability. The two wavelengths generated by this method are closely spaced around the pump wavelength and cannot be used to extend the tuning range far from the pump wavelength.

Conventional optical fibres have a central core surrounded by glass with a slightly different composition to the central core. Typically the central core is doped so that it has a different refractive index to the surrounding glass. Light travelling down the central core of the fibre is confined by the interface between the fibre and the surrounding glass.

In the last few years a non-standard type of optical fibre has been demonstrated, called photonic crystal fibre. Typically, this is made from a single solid and substantially transparent material such as silica within which is embedded an array of air holes. The holes run parallel to the fibre axis and extending the full length of the fibre. The arrangement of air holes in the array may be periodic but need not be and the air holes may be filled with a material other than air. A defect, for example, in the form of a single missing air hole within the regular array forms a region of raised refractive index within which light is guided, in a manner analogous to total-internal-reflection guiding in standard fibres. Another mechanism for guiding light in a photonic crystal fibre is based on photonic-band-gap effects rather than total internal reflection. Photonic-band-gap guidance can be obtained by suitable design of the array of air holes. Light with particular propagation constants can be confined to an air core and will propagate therein. A photonic crystal fibre can be fabricated by stacking glass canes, some of which are capillaries on a macroscopic scale, into the required shape, and then holding them in place while fusing them together and drawing them down into a fibre. A photonic crystal fibre has unusual properties such as the ability to guide light in a single-mode over a very broad range of wavelengths, and to guide light having a relatively large mode area which remains single-mode.

Photonic crystal fibres have the potential to greatly increase the number of fibre based optical devices as they have a wide range of properties that can be engineered to suit the application.

### SUMMARY OF INVENTION

It is an object of the present invention to provide an efficient tuneable optical amplifier that can convert pump light to a range of other wavelengths, or at least provides the public with a useful choice.

In a first aspect the invention broadly consists in a parametric process for producing light at a second wavelength and a fourth wavelength including pumping an optical parametric oscillator with input light at a first wavelength of less than one micron, wherein said oscillator consists of an optical fibre having each end closed by a dichroic mirror.

Preferably the optical fibre has zero group velocity dispersion at a third wavelength in the visible or near infrared region and longer than the first wavelength.

Preferably each mirror is substantially reflective to the fourth wavelength.

Preferably each mirror is substantially transmissive to the second wavelength and the first wavelength.

Preferably the input light wavelength is longer than said second wavelength.

Preferably the input light wavelength is shorter than said second wavelength.

Preferably the input light wavelength is approximately 720 nm.

Preferably the fibre having each end closed by a dichroic mirror further comprises butt-coupling a dichroic mirror to each end of said optical fibre.

Preferably the fibre having each end closed by a dichroic mirror further comprises a dichroic mirror deposited directly to each end of said optical fibre.

Preferably the dichroic mirror has a reflectivity of at least 30% for wavelengths between 750 and 1000 nm.

Preferably the dichroic mirror is substantially transmissive for wavelengths between 500 and 725 nm.

Preferably the dichroic mirror has a reflectivity of at least 30% for wavelengths between 450 and 690 nm.

Preferably the dichroic mirror is substantially transmissive for wavelengths between 700 and 1300 nm.

Preferably the parametric process is tuneable by adjusting the frequency of the zero group velocity dispersion.

Preferably the parametric process is tuneable by adjusting physical influences on said fibre.

Preferably the parametric process is tuneable by adjusting said first wavelength.

Preferably the parametric process is tuneable by adjusting the birefringence of said optical fibre.

Preferably the fibre is a photonic crystal fibre.

In another aspect the invention broadly consists in an optical amplifier that uses an optical parametric amplifier for producing light at a second wavelength and a fourth wavelength, comprising:

a pump source providing input light at a first wavelength, and

a parametric oscillator wherein said oscillator comprises an optical fibre having each end closed by a dichroic mirror.

Preferably the optical fibre has zero group velocity dispersion at a third wavelength in the visible or near infrared region and longer than said first wavelength.

Preferably each mirror is substantially reflective to said fourth wavelength.

Preferably each mirror is substantially transmissive to said second wavelength and said first wavelength.

Preferably the input light wavelength is longer than said second wavelength.

Preferably the input light wavelength is shorter than said second wavelength.

Preferably the input light wavelength is approximately 720 nm.

Preferably the fibre having each end closed by a dichroic mirror further comprises butt-coupling a dichroic mirror to each end of said optical fibre.

Preferably the fibre having each end closed by a dichroic mirror further comprises a dichroic mirror deposited directly to each end of said optical fibre.

Preferably the dichroic mirror has a reflectivity of at least 30% for wavelengths between 750 and 1000 nm.

Preferably the dichroic mirror is substantially transmissive for wavelengths between 500 and 725 nm.

Preferably the dichroic mirror has a reflectivity of at least 30% for wavelengths between 450 and 690 nm.

Preferably the dichroic mirror is substantially transmissive for wavelengths between 700 and 1300 nm.

Preferably the amplifier is tuneable by adjusting the frequency of the zero group velocity dispersion.

Preferably the amplifier is tuneable by adjusting physical influences on said fibre.

Preferably the amplifier is tuneable by adjusting said first wavelength.

Preferably the amplifier is tuneable by adjusting the birefringence of said optical fibre.

Preferably the fibre is a photonic crystal fibre.

In another aspect the invention broadly consists in an optical amplifier comprising an optical fibre adapted to receive input light of approximately 720 nm, the fibre having each closed by a dichroic mirror to thereby form a parametric oscillator operable to generate light at wavelengths above and below the input light wavelength, the optical fibre having zero group velocity dispersion at a wavelength longer than the input light, wherein the mirrors are partially reflective to the light generated above the input light wavelength and substantially transmissive for light generated below the input light wavelength and the input light.

It is not the intention to limit the scope of the invention to the abovementioned examples only. As would be appreciated by a skilled person in the art, many variations are possible without departing from the scope of the invention (as set out in the accompanying claims).

### BRIEF DESCRIPTION OF DRAWINGS

The invention will be further described by way of example only and without intending to be limiting with reference to the following drawings, wherein:

FIG. 1 shows one embodiment of the invention that can be operated as an optical parametric amplifier.

FIG. 2 shows a result of a ring-down type trace measurement of the cavity of FIG. 1.

FIG. 3 shows a phase-matching curve for a photonic crystal fibre and a pump power of 30 W. Inset is a dispersion curve for a photonic fibre indicative of a zero group velocity dispersion wavelength.

FIG. 4 shows a walk-off factor between a pump, Stokes and anti-Stokes sidebands as a function of pump wavelength detuning.

FIG. 5 shows spectra of a series of combined outputs from the cavity of FIG. 1. Inset is the measured Stokes and anti-Stokes sideband frequency shift as a function of a varying pump wavelength.

### DETAILED DESCRIPTION

Scalar modulation instability, which leads to breaking up of an intense continuous wavelength beam, is the simplest form of modulation instability that can occur in optical fibres. This process can also be viewed as a four wave mixing process, leading to the development of symmetrically placed sidebands on either side of the pump wavelength, whose position is determined by the phase matching condition. The conventional analysis of scalar modulation instability (also called parametric amplification) shows that modulation instability gain is only obtained in the anomalous dispersion region where the wave-vector mismatch Δk=β₂Ω² is balanced by self phase modulation, where Δk is the phase mismatch, β₂ is the dispersion parameter, and Ω is the frequency shift of the sidebands. Using this theory, the modulation instability gain vanishes for β₂>0.

This conventional analysis is based on the one dimensional nonlinear Schrödinger equation, which leads to the widely accepted results that scalar modulation instability occurs only in the anomalous dispersion regime of a single mode optical fibre. This conclusion however, is a result of using a nonlinear Schrödinger equation derived using a Taylor expansion of the propagation constant up to the second order.

In a photonic crystal fibre there is a strong waveguide dispersion contribution to the dispersion profile. This means that the conventional approximation of expanding the dispersion constant to second order is inadequate. The use of the nonlinear Schrödinger equation to study modulation instability shows that the odd order terms do not contribute to the condition governing the parametric gain of the sidebands, and consequently the first higher order term to be important is the fourth order dispersion term.

In a photonic crystal fibre according to the embodiments of the present invention, the steady state solution to the equation governing the propagation of pulses down the fibre in the presence of nonlinearity and dispersion (the nonlinear Schrödinger equation) is given by A=\sqrt{P} exp(iγPz). This is perturbed at frequency Ω by substituting:

A=(\sqrt{P}+a)exp(iγPz)

and linearising the resulting equation for the perturbation where

a(z,T)=a₁ cos(kz−ΩT)+ia₂ sin(kz−ΩT)

this yields the following dispersion relation:

$$k = \frac{{β}_{3} {Ω}^{3}}{6} \pm {\{ ( \frac{{β}_{2} {Ω}^{2}}{2} + \frac{{β}_{4} {Ω}^{4}}{24} ) ( \frac{{β}_{2} {Ω}^{2}}{2} + \frac{{β}_{4} {Ω}^{4}}{24} + 2 γ P ) \}}^{1 / 2}$$

where it is clear that an imaginary wave number (corresponding to gain for the perturbation) is obtained only for β₂+β₄Ω²/12<0, and |β₂+β₄Ω²/12|Ω²<4γP. This defines a relatively narrow frequency region close to that given by the linear phase matching condition Ω=[−12β₂/β₄]^{1/2}.

Phase-matched parametric gain occurs when the linear mismatch set by the fibre dispersion exactly cancels the nonlinear mismatch set by the nonlinear phase shifts as experienced by the three waves. This condition can be written as:

β(ωₚ+Ω)+β(ωₚ−Ω)−2β(ωₚ)+2γP=0

Where β is the fibre linear wave-vector, γ is the fibre nonlinear interaction coefficient, ωₚ is the pump frequency, Ω is the sideband detuning and P is the pump power.

The use of a photonic crystal fibre dispersion shifted into the visible or near infrared ensures that β₄ (the fourth order dispersion term) is relatively large and of opposite sign to β₂ in the normal dispersion region close to the zero dispersion wavelength.

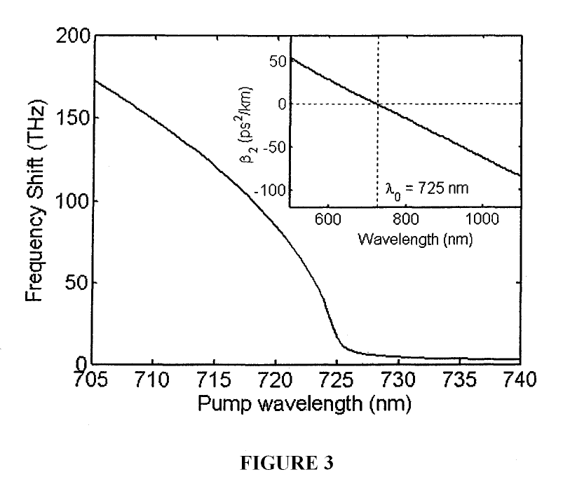

The dispersion value of a photonic crystal fibre used for experimental verification of this technique was measured to be at approximately 725 nm as shown inset to FIG. 3. The phase-matching curve for this fibre is obtained using this dispersion curve. FIG. 3 shows the phase-matching curve for a pump power of 30 W. As the pump wavelength is tuned from 725 to 705 nm the phase-matched sideband frequency shift is continuously tuned from 20 to 170 THz.

Those skilled in the art will appreciate that the phase matching model can be applied to many other combinations of fibres having different zero dispersion wavelengths combined with close pump wavelengths.

In addition to the phase-matching curve the dispersion of the fibre also governs the walk-off between the pump wave and the two generated sideband waves. Walk-off is an important parameter for the operation of a fibre optical parametric oscillator when using short pulses. The walk-off sets the upper limit for the tuning range.

Photonic crystal fibre has a small core diameter with a large “air filling fraction”. Using input light with a wavelength around 700 nm enables the use of readily available solid state pump lasers. However, input light at other wavelengths can also be used so long as the input light is at a shorter than, but near to the zero group velocity dispersion wavelength.

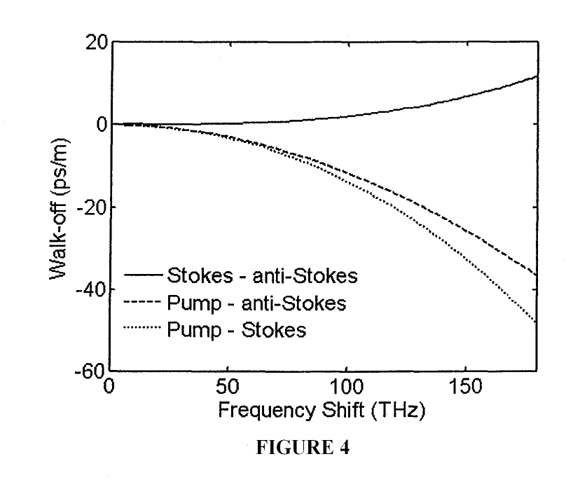

FIG. 4 shows the walk-off in the photonic crystal fibre between the pump, Stokes and anti-Stokes waves as a function of detuning. The walk-off between the sidebands and the pump exceeds 20 ps/m for detuning shifts above 100 THz. For example, an 8 ps pulse length corresponds to a parametric amplification interaction length below 0.5 m. A reduced interaction length results in a corresponding reduction in net parametric gain.

Using a photonic crystal fibre with zero group velocity dispersion in the red region of the spectrum, parametric gain for wavelengths from deep blue to orange for a red pump wavelength depending on the relative values of (the second and fourth order dispersion terms) β₂ and β₄.

A photonic crystal fibre may readily be dispersion shifted into the visible or near infrared region of the spectrum to take advantage of the solid state pump lasers which are available at these wavelengths. The technique of dispersion shifting a photonic crystal fibre is well known. The use of such a dispersion shifted photonic crystal fibre allows the efficient generation of light at a shorter wavelength (blue, green, yellow or orange), which can readily be tuned by tuning the pump source over a relatively much smaller wavelength range.

Use of a photonic crystal fibre enables the phase matching of any desired wavelength in the visible region to that of the pump wavelength and another wavelength in the infrared when pumping the fibre in the normal dispersion regime near to the zero dispersion wavelength (also called the zero group velocity dispersion wavelength).

The strong waveguide contribution to the dispersion curve of a photonic crystal fibre materially assists this phase matching process. Waveguide contribution to dispersion does not occur, or only occurs over a very small region close to the zero dispersion wavelength when using conventional silica based fibre waveguides. Conventional silica based fibre waveguides only permit the production of fibres with a zero dispersion wavelength longer than 1.25 microns.

The decreased effective area of the propagation mode of a photonic crystal fibre also greatly enhances the nonlinear and parametric effects over standard fibres designed to be single mode in the region of the pump wavelength.

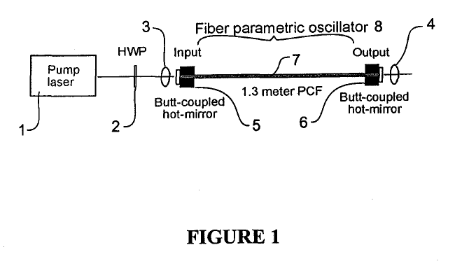

FIG. 1 shows an embodiment of the invention that provides optical parametric amplification by way of a Fabry-Perot cavity 8 oscillator. The Fabry-Perot cavity 8 is a optical fibre parametric oscillator that provides a wide tuneable range of output wavelengths. The Fabry-Perot cavity 8 has been demonstrated to advantageously produce parametric amplification at a lower pump power than other known methods. The lower pump power is a direct result of increased system efficiency.

The Fabry-Perot cavity 8 is formed by closing the ends of a highly nonlinear index-guiding photonic crystal fibre 7 with dichroic mirrors 5, 6. The cavity 8 can be said to be singly resonant.

A laser pump source 1 provides an input light source to the cavity 8. The pump light is coupled into the cavity by a first objective 3. Similarly, light is coupled out of the cavity and collimated by a second objective 4. A half-wave plate 2 is used to adjust the polarisation angle of the input light.

Closing of the fibre 7 with dichroic mirrors 5, 6 can be effected in several ways. A preferred way is to butt-couple a dichroic mirror to each fibre end. Alternatively, the dichroic mirrors can be deposited directly onto each end of the fibre.

Butt-coupling of the mirrors 5, 6 to each end of the fibre 7 is achieved by precisely aligning the ends of the fibre 7 perpendicular to the mirrors 5, 6. The fibre ends are then advanced toward each mirror until the fibre ends touch. Alternatively, the fibre can be held in a fixed position and the mirrors advanced toward each fibre end, or some combination of both. Each mirror and fibre end is mechanically secured in place to provide a high-quality stable butt-couple. No index-matching fluid is necessary. Directly depositing the mirrors would result in an even higher cavity resonance and therefore lower required input power to produce parametric effects.

The reflectivity of each dichroic mirror 5, 6 are chosen to reflect one of the generated sidebands and substantially transmit the pump and other sideband. Preferably, when visible light is wanted, the anti-Stokes (frequency up-shifted) sideband and pump are substantially transmitted from the cavity 8 while the Stokes (frequency down-shifted) sideband is reflected within the cavity 8. Adequate reflectivity of the resonant sideband is provided by reflecting at least 30% of the unwanted sideband within the cavity 8.

The all-fibre nature of this cavity design results in a robust completely self-aligned resonant parametric oscillator. The advantage of using a resonant cavity is that less input power is needed to produce sidebands. A further advantage of using a resonant cavity is that a narrower line width can be achieved in the output light

The pump light 1 can be any wavelength close to, but slightly less than, the wavelength of the zero dispersion wavelength of the fibre 7. To produce blue or green light from the anti-Stokes sideband it is advantageous to have a pump wavelength and fibre zero dispersion wavelength in the yellow/orange/red region of the spectrum.

The photonic crystal fibre 7 used for experimental verification of one embodiment of the invention has a solid silica core with a diameter of approximately 1.8 μm and a cladding air filling fraction of 70%. The photonic crystal fibre exhibits a weak birefringence (Δn˜10-4) and can be considered as polarization preserving for the short 1.3 m length used in experimental verification of the invention.

The experimental results presented here for a pump polarization angle aligned parallel to the high-group-index mode of the fibre. Similar results could be obtained with the pump polarization parallel to the low-group-index mode. The small core and high core cladding index-step shift the zero dispersion wavelength of the photonic crystal fibre of the high group-index-mode to 725 nm.

The quality of the Fabry-Perot cavity 8 is tested using a cavity ring-down measurement. A pulsed pump light source is coupled into the cavity 8. The pulse source is a modelocked Ti:Sapphire laser producing 8 ps pulses at approximately 830 nm. The repetition rate of the pulses is adjustable from 79.3 to 80.4 MHz. The repetition rate of the pulses is far detuned from the round-trip time of the cavity such that multiple cavity reflections can be observed. The mirrors 5, 6 are chosen such that they are strongly reflective to the wavelength of the pump light.

Preferably the round trip time of input pulses in the cavity 8 are synchronised with the input pulse repetition rate during normal operation. However, the cavity 8 could be operated as an optical amplifier if the round trip time of the oscillator is not synchronised with the repetition rate of the pump laser. Synchronisation of the round trip time with the pump laser is only required when the laser is pulsed. Synchronisation of the round trip time is not required when the pump laser is operating in continuous mode.

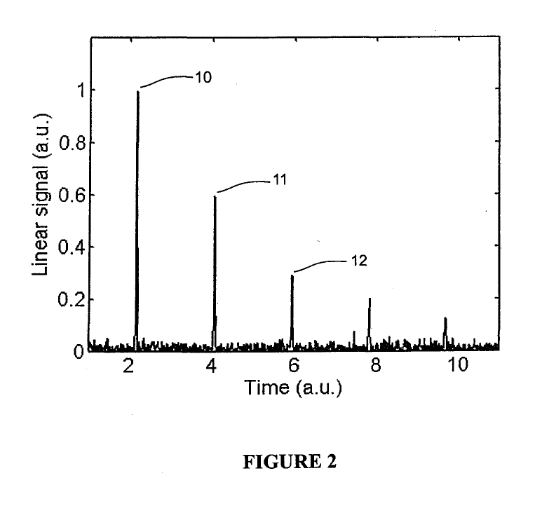

FIG. 2 shows the output ring-down signal of the cavity 8 observed on a streak camera for a 1.3 m length of photonic crystal fibre. The first peak 10 shown in FIG. 2 corresponds to an input pulse which has travelled straight though the cavity 8. The second peak 11 corresponds to an input pulse that has been reflected at the cavity 8 end mirror 6 and thus has completed an additional round-trip. The third peak 12 corresponds to an input pulse that has completed two additional round-trips, and so on.

The ratio of the intensities between two successive peaks in the ring-down signal provides the feedback fraction of the cavity for a resonant sideband. The ratio of the signals in FIG. 2 is measured to be 60%. This implies that the loss of each butt-coupled mirror 5, 6 is approximately 2%. The loss characteristic of the photonic crystal fibre in use has been measured to be 80 dB/km (at 700 nm). Attenuation of the light in the fibre is therefore negligible for short fibre lengths such as the 1.3 m length used here.

There are two conditions that need to be satisfied for the cavity 8 to begin oscillating. First, the repetition rate of the pump laser 1 must be matched to the reciprocal of the round-trip time of the resonant sideband in the cavity 8. Second, the pump power must be sufficiently high, or surpass a threshold, such that the parametric gain exceeds the resonant sideband's round-trip loss.

The threshold condition for a continuous wave pump source can be written as:

γPL>a cos h(α^{-1/2})

Where L is the fibre length and α is the feedback fraction of the resonant sideband. This equation predicts a theoretical threshold power of only 9 W for the cavity presented here. This threshold is the result of the long fibre length and is much lower than other known oscillators. The low threshold is also contributed by the high feedback fraction for the resonant sideband.

The dichroic mirrors used to close the fibre to form an input and output of the cavity oscillator, for experimental verification of the preferred embodiment of the invention, are “hot” mirrors. These mirrors are 80% transmitting for wavelengths from 500 to 725 nm and more than 95% reflecting for wavelengths from 750 to 1000 nm. This results in a Fabry-Perot cavity with a roundtrip loss of 40% for the resonant Stokes sideband, including the residual losses due to the butt-couple fibre closing technique. The residual feedback of the pump and the anti-Stokes sideband is calculated to be less than 4%.

Temporal walk-off between the three waves results in a further reduction in the residual feedback of these two non-resonant waves. Therefore a good approximation of this oscillator is that of a singly resonant cavity and hence operates in a phase-insensitive regime. This provides a further advantage that there is no requirement for any active stabilization of the length of the oscillator.

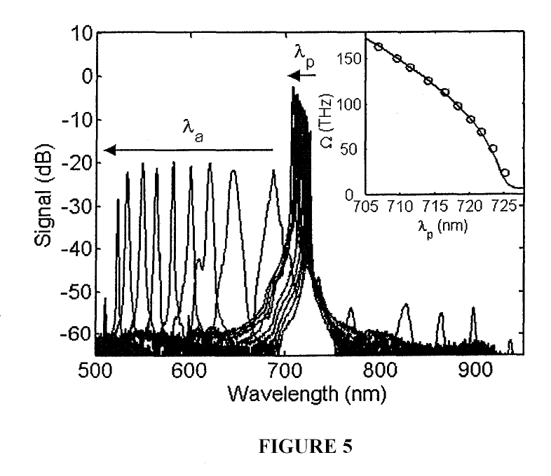

FIG. 5 shows the measured spectra of the output of the fibre oscillator for ten different pump wavelengths ranging from 725 to 707 nm. Each pump wavelength generates one pair of narrowband parametric sidebands symmetrically detuned in frequency either side of the pump. The generated anti-Stokes signals are clearly visible from 687 to 510 nm.

The remnants of the Stokes signals transmitted through the output hot-mirror can also be seen on the long wavelength side of the pump. The 3 dB bandwidth of the anti-Stokes sidebands varies from 4 nm at 687 nm to less than 1 nm at 510 nm.

The peak pump power at 725 nm is 30 W. As the sideband detuning is increased the net parametric gain drops due to the increased walk-off between the three waves. To counter this, the peak pump power is increased in a roughly linear fashion with the pump power at 707 nm approximately 100 W.

The peak pump power quoted here is the pump power in the fibre directly after the input dichroic mirror 5. The threshold power for the 23 THz sideband (pump wavelength 725 nm) is measured to be 15 W. This is in reasonable agreement with the 9 W threshold predicted by the continuous wave theory. This power threshold is an order of magnitude lower than the threshold of other known oscillators. The resulting frequency detuning of the output sideband is from 687 to 510 nm (23 to 164 THz) for a pump wavelength around 720 nm.

The inset to FIG. 5 shows the measured sideband frequency shift as a function of the pump wavelength (open circles). The solid line is the theoretical prediction. The cavity 8 embodying the invention therefore provides a relatively simple way of constructing a narrowband, widely tuneable, low threshold power parametric oscillator.

It can be appreciated by those skilled in the art that for photonic crystal fibres having a lower zero dispersion wavelength offset, a similar tuning range could be achieved for a lower associated pump wavelength and range of output wavelengths.

In addition to tuning the sideband wavelengths by changing the pump wavelength, the frequency converter can be tuned by several other methods including adjusting the birefringence of the photonic crystal fibre, adjusting the position of the zero group velocity dispersion, changing the stress or other physical influences on the fibre.

In another embodiment of the present invention the oscillator is built with cold-mirrors rather than hot-mirrors. This results in the anti-Stokes sideband becoming resonant in the cavity while the Stokes sideband is output from the cavity. The resulting tuning range would be 768 to 1150 nm.

In another embodiment of the present invention the output dichroic mirror 6 is a broadband partially reflective mirror. This type of mirror would allow both sidebands to be simultaneously coupled out of the cavity, but at the expense of a lower cavity resonance, and hence a lower maximum achievable sideband detuning.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art

The term “comprising” as used in this specification means “consisting at least in part of”. Related terms such as “comprise” and “comprised” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

1. A parametric process for producing light at a second wavelength and a fourth wavelength including pumping an optical parametric oscillator with input light at a first wavelength of less than one micron, wherein said oscillator consists of an optical fibre having each end closed by a dichroic mirror.

2. A parametric process as claimed in claim 1 wherein said optical fibre has zero group velocity dispersion at a third wavelength in the visible or near infrared region and longer than said first wavelength.

3. A parametric process as claimed in claim 1 wherein each mirror is substantially reflective to said fourth wavelength.

4. A parametric process as claimed in claim 3 wherein each mirror is substantially transmissive to said second wavelength and said first wavelength.

5. A parametric process as claimed in claim 1 wherein said input light wavelength is longer than said second wavelength.

6. A parametric process as claimed in claim 1 wherein said input light wavelength is shorter than said second wavelength.

7. A parametric process as claimed in claim 1 wherein said input light wavelength is approximately 720 nm.

8. A parametric process as claimed in claim 1 wherein said fibre having each end closed by a dichroic mirror further comprises butt-coupling a dichroic mirror to each end of said optical fibre.

9. A parametric process as claimed in claim 1 wherein said fibre having each end closed by a dichroic mirror further comprises a dichroic mirror deposited directly to each end of said optical fibre.

10. A parametric process as claimed in claim 5 wherein each said dichroic mirror has a reflectivity of at least 30% for wavelengths between 750 and 1000 nm.

11. A parametric process as claimed in claim 10 wherein each said dichroic mirror is substantially transmissive for wavelengths between 500 and 725 nm.

12. A parametric process as claimed in claim 6 wherein each said dichroic mirror has a reflectivity of at least 30% for wavelengths between 450 and 690 nm.

13. A parametric process as claimed in claim 12 wherein each said dichroic mirror is substantially transmissive for wavelengths between 700 and 1300 nm.

14. A parametric process as claimed in claim 1 wherein the parametric process is tuneable by adjusting the frequency of the zero group velocity dispersion.

15. A parametric process as claimed in claim 1 wherein the parametric process is tuneable by adjusting physical influences on said fibre.

16. A parametric process as claimed in claim 1 wherein the parametric process is tuneable by adjusting said first wavelength.

17. A parametric process as claimed claim 1 wherein the parametric process is tuneable by adjusting the birefringence of said optical fibre.

18. A parametric process as claimed in claim 1 wherein said fibre is a photonic crystal fibre.

19. An optical amplifier that uses an optical parametric amplifier for producing light at a second wavelength and a fourth wavelength, comprising:
a pump source providing input light at a first wavelength, and
a parametric oscillator wherein said oscillator comprises an optical fibre having each end closed by a dichroic mirror.

20. An optical amplifier as claimed in claim 19 wherein said optical fibre has zero group velocity dispersion at a third wavelength in the visible or near infrared region and longer than said first wavelength.

21. An optical amplifier as claimed in claim 19 wherein each mirror is substantially reflective to said fourth wavelength.

22. An optical amplifier as claimed in claim 21 wherein each mirror is substantially transmissive to said second wavelength and said first wavelength.

23. An optical amplifier as claimed in claim 19 wherein said input light wavelength is longer than said second wavelength.

24. An optical amplifier as claimed in claim 19 wherein said input light wavelength is shorter than said second wavelength.

25. An optical amplifier as claimed in claim 19 wherein said input light wavelength is approximately 720 nm.

26. An optical amplifier as claimed in claim 19 wherein said fibre having each end closed by a dichroic mirror further comprises butt-coupling a dichroic mirror to each end of said optical fibre.

27. An optical amplifier as claimed in claim 19 wherein said fibre having each end closed by a dichroic mirror further comprises a dichroic mirror deposited directly to each end of said optical fibre.

28. An optical amplifier as claimed in claim 23 wherein each said dichroic mirror has a reflectivity of at least 30% for wavelengths between 750 and 1000 nm.

29. An optical amplifier as claimed in claim 28 wherein each said dichroic mirror is substantially transmissive for wavelengths between 500 and 725 nm.

30. An optical amplifier as claimed in claim 24 wherein each said dichroic mirror has a reflectivity of at least 30% for wavelengths between 450 and 690 nm.

31. An optical amplifier as claimed in claim 30 wherein each said dichroic mirror is substantially transmissive for wavelengths between 700 and 1300 nm.

32. An optical amplifier as claimed in claim 19 wherein said amplifier is tuneable by adjusting the frequency of the zero group velocity dispersion.

33. An optical amplifier as claimed in claim 19 wherein said amplifier is tuneable by adjusting physical influences on said fibre.

34. An optical amplifier as claimed in claim 19 wherein said amplifier is tuneable by adjusting said first wavelength.

35. An optical amplifier comprising:
an optical fibre adapted to receive input light of approximately 720 nm, said fibre having each closed by a dichroic mirror to thereby form a parametric oscillator operable to generate light at wavelengths above and below the input light wavelength, said optical fibre having zero group velocity dispersion at a wavelength longer than said input light,
wherein said mirrors are partially reflective to said light generated above said input light wavelength and substantially transmissive for light generated below said input light wavelength and said input light.
